(19) United States
(12) Patent Application Publication
(10) Pub. No.: US 2012/0321062 A1
(43) Pub. Date: Dec. 20, 2012

(54) Telephonic Conference Access System

(76) Inventors: Jeffrey E. Fitzsimmons, Milwaukee, WI (US); Matthew Stockton, Milwaukee, WI (US); Marc Della Torre, San Jose, CA (US)

(21) Appl. No.: 13/313,900

(22) Filed: Dec. 7, 2011

Related U.S. Application Data
(63) Continuation-in-part of application No. 13/163,314, filed on Jun. 17, 2011.

(51) Int. Cl. H04M 15/06; H04M 3/42

(52) U.S. Cl. 379/142.17; 379/202.01; 379/142.01

(57) ABSTRACT

A conference call system provides multidimensional indexing of recorded audio data through connecting the audio stream to adjunct data generated by the conference call participants during the conference call or thereafter and or/by automatic audio analysis of the audio data. The conference call may be initiated by outgoing calls to the conference participants reducing the burden to those participants for remembering and connecting to the conference call.

### CROSS REFERENCE TO RELATED APPLICATION

This application is a continuation-in-part of U.S. application Ser. 13/163,314 filed Jun. 17, 2011 and titled “System and Method for Synchronously Generating an Index to a Media Stream” hereby incorporated by reference.

### BACKGROUND OF THE INVENTION

The present invention relates to telephonic communication systems and in particular to a system and method for improving the management, efficiency and value of telephonic conferences between two or more people in the access to the audio data of recorded telephonic conferences.

Telephonic conferences remain a mainstay of business communication for individuals who are geographically dispersed. With the growth of the cellular phone industry, telephone connections and handsets are practically available to potential conference participants at a moment's notice and the intermarriage of telephonic and computer-based communications make the interconnection of many individuals on different telephone networks and different locations readily achievable. Computer management of telephone conference calls has made it a simple matter to record the call to provide a record of the conference.

Those who employ telephone conference calls as a mode of group communication recognize the problem of coordinating the individuals participating in the conference who typically must remember to call a central number and memorize the central call-in number as well as a conference call code required to connect them to the particular conference group. A password may also be required in some cases. It is not atypical for a conference to be delayed while calls are made to particular individuals who have failed to connect. The need sometimes to download software to a user's host computer before participation is permitted is still another complication with certain systems.

Recording the conference call is often useful for those who have missed the conference or those who desire to refresh their recollections of the conversations during the call. The linear nature of recorded audio, however, makes a recorded conference call relatively inaccessible, cumbersome, and unattractive as a way of providing future reference to the subject of the conference. In cases where such extensive future reference to a conference is required, a transcription of the conference is normally produced.

Intracall dynamics are also problematic during a conventional conference call. Because participants call from dispersed locations those participating find it difficult to interact without speaking over other's conversations and this is especially true when the discussion is one with high energy levels. Due to the scattered locations where participants reside for the call, it is difficult if possible at all to coordinate comments and replies inasmuch as the cuing for these important aspects of the discussions are nonverbal. This inhibits effective communication during the call when some participants hold back comments or renders the thread of discussion less meaningful when many try to comment at once.

### SUMMARY OF THE INVENTION

The present invention substantially improves the ease of establishing accessibility of recorded audio data from a telephone or other conference by allowing multidimensional indexing of the recorded audio not simply by time, as is conventionally done, but also by adjunct data such as tags referencing portions of the call. Tags may be placed automatically and/or by the call participants. The tags may be selected from pre-generated tag types or free-form text entered by the users as well as other tag types. The audio data may be marked with adjunct data on a semiautomatic basis through machine analysis of the audio stream, for example to identify speakers, gender, and vocal characteristics. The subsequently recorded audio may then be rapidly accessed in a nonlinear fashion through any of the dimensions of indexing of time and any of these tag types. Importantly, these additional dimensions of indexing allow searching among multiple audio files for common or conflicting information.

Participants may record comments as well as placing tags on the audio stream of the call. The comments may be an analog to normal note taking by some call participants, and these comments may be taken for private use or for sharing with some or all others on the call. In the latter case, theses notes may resemble a form of “chat” much like the kinds of quiet conversations among those attending a live meeting (e.g.' a “side bar”). Notes and comments then provide another type of indexing that facilitates search at a later time.

Another feature of the invention greatly simplifies connecting to conference participants by inverting the normal model of a conference call requiring the participants to call a central number. Instead the invention institutes outgoing calls to the conference participants at the appropriate time. The self-authentication of the telephone system and this centralized out-calling eliminates the need for the participants to memorize a central telephone number, input a conference number distinguishing among multiple simultaneous conferences, or to provide authentication, the latter which is automatic in the uniqueness of individual telephone numbers.

In highly preferred embodiments, participants are provided a dashboard to be used during the conference call. The dashboard may be displayed in any device that allows for interactivity and visual display so is not confined to a computer screen. Thus, this extends the utility of the present methods and systems to tablets, smartphones and other devices that preferably connect via the Internet to the call. In these embodiments, the host or participants can upload documents or graphics for sharing with the group on the call, whether a written agenda, PowerPoint presentations or information presented in like form or fashion. These documents may be auto tagged or tagged with or without notes or comments by call participants. Specifically, these documents may be subject to “passive tagging” in which actions such as navigating to the next slide or next agenda item automatically generate tags even without other action by the call participants. In this way, the relevant audio data related to a particular slide or agenda item may be quickly identified in the recorded audio record.

Specifically then, the present invention provides methods and systems improving the effective communication, capture and accessibility of recorded conversations among individuals in which a received audio stream is associated with the participating individuals, the audio stream including sampled audio data associated with time values. The most conventional application of the methods and systems of the present invention will be conference calls in which participants join via telephone whether landline or mobile or another telephone substitute such as a microphone/headset associated with a device connecting via VOIP or a functional equivalent. Adjunct data related to the audio stream and associated with the time value is also received and the audio stream and adjunct data is recorded with the adjunct data linked through the time values to the audio data. The system may accept a search request from an individual for a portion of the audio stream related to either or both dimensions of time value and adjunct data to output a portion of the audio stream related to the time value or adjunct data.

It is thus a feature of at least one embodiment of the invention to permit multidimensional access to a normally one-dimensional audio stream thereby greatly improving the accessibility of recorded telephone conferences. In this sense, one can envisage the audio stream as one-dimensional in a time frame, whereas at least one further dimension is provided such as tags, comments, notes or the like that facilitates search, retrieval and/or management of the audio stream in ways that increase its value to participants or their organizations.

The adjunct data may be received over the Internet or otherwise from the individuals during the receipt of the audio stream from the telephone system.

It is thus a feature of at least one embodiment of the invention to permit the use of the Internet for the addition of complex adjunct data to an audio call.

The adjunct data may consist of annotations input into remote computing devices by the individuals to generate the audio stream.

It is thus a feature of at least one embodiment of the invention to utilize sophisticated computer hardware normally available to call participants.

The annotations may be any or all of predetermined menu items denoting different assessments of content of the audio stream and free-form text notations.

It is thus a feature of at least one embodiment of the invention to permit rapid annotation consistent with a real-time telephone call while allowing the flexibility and preciseness of free-form text notes, both which can be used for indexing of the audio stream.

The predetermined menu items may be any or all of a menu item indicating an important conversational point in the audio stream and/or a menu item indicating a conversational point in the audio stream requiring a subsequent action.

It is thus a feature of at least one embodiment of the invention to capture important impressions of the conference participants as they occur tied to the audio influencing those impressions.

The annotation may indicate a degree of consensus of the individuals participating in the conference call. For example, the degree of consensus may be represented as a numerical vote outcome of the individuals polled during the call or by spontaneous notes, comments and/or tags associated with a particular segment of the audio stream. The degree of interest consensus (or lack of consensus) of the multiple parties can inferentially obtained, and in some cases automatically tagged, the inference being based, for example, on any or on combinations of the number of tags during a given audio segment, and/or on particular words mined from those tags (for example identified with respect to “positive words” and “negative words” using known sentiment analysis programs).

Similarly, a matching of words transcribed from the audio data for particular segments can be compared to the words in the comments to provide a ranking of the significance of that audio data (as relates to the manifest interest by the participants making the comments). For example, in this latter case, a discussion of “profitability” in the conference could be tagged with an indication of how many comments discuss profitability anywhere in the conference. Of course, tables of synonyms can be used to expand the scope of this tagging process as well as text analytics engines that may be used to distinguish among homophones. This tagging process also allows comments to be quickly identified to relevant portions of the audio program outside the location of the comment tag, greatly facilitating searching as will be described below.

It is thus a feature of at least one embodiment of the invention to capture collaborative efforts resulting from the free exchange of ideas in a conference call and employ the same as an index point in the audio stream.

The adjunct data may include identification of electronic documents displayed to the participants over the Internet.

It is thus a feature of at least one embodiment of the invention to provide a system that works with various remote “whiteboard” systems for sharing documents and images during a telephone conference to use such document displays as index points for the audio stream.

The adjunct data may include a making of annotations to the electronic documents by the individuals during the call, the annotations identifying an electronic document being annotated and the annotations.

It is thus a feature of at least one embodiment of the invention to capture collaborative modification to documents as indexes to audio data.

The adjunct data may be generated by a program running on an electronic computer analyzing the audio stream to provide adjunct data related to the content of the text stream.

It is thus a feature of at least one embodiment of the invention to permit automatic or semiautomatic analysis of the audio stream to create index-ready tags.

The adjunct data may be any or both of a text transcription of the audio stream and identification of speaker characteristics of individuals recorded in the audio stream. The speaker characteristics may be any or all of gender, emotional state, and loudness.

It is thus a feature of at least one embodiment of the invention to extract indexable information from the audio stream that would be cumbersome or costly if done by an individual.

The invention may provide a method or apparatus for telephone conference calls using an electronic computer communicating electronically with a public switched telephone network to a set of conference call participants and telephone numbers and, at a time of the conference call, initiate calls to the call participants. Upon pickup of the computer-initiated calls by the call participants, the electronic computer may join the call participants together in a conference call.

It is thus a feature of at least one embodiment of the invention to provide a system that eliminates the need for conference call participants to call in at a particular time.

The conference call system may further e-mail to the conference call participants a web addressed providing for intercommunication between the conference call participants over the web.

It is thus a feature of at least one embodiment of the invention to provide a system that may be expanded to permit Web participation.

The system may further include multiple telephone numbers for call participants to move through the numbers after a predetermined period of time if call participants do not pick up.

It is thus a feature of at least one embodiment of the invention to greatly reduce the need to track down individuals who may have multiple telephone numbers.

The invention may permit the receipt of instructions either directly or indirectly from at least one call participant for a change in telephone numbers and, in response, initiate a call to the one call participant on the new telephone number to join the one call participant together in the conference call.

It is thus a feature of at least one embodiment of the invention to provide a system that flexibly allows reassignment of telephone numbers during the conference call that flexibly allows reassignment of telephone numbers and individuals during the conference call.

These particular features and advantages may apply to only some embodiments falling within the claims and thus do not define the scope of the invention.

### BRIEF DESCRIPTION OF THE DRAWINGS

FIG. 1 a block diagram of hardware elements employed in one embodiment of the invention providing a central server communicating with remote users both via a standard telephone network and Internet connected remote computers;

FIG. 2 is a fragmentary screen display implemented on a remote computer used to collect information identifying outgoing telephone numbers for initiation of a telephonic conference call together with automatic e-mail reminders;

FIG. 3 is a block diagram of the hardware elements accessible to users of the remote computers in various embodiments;

FIG. 4 is a flowchart executed by the server of FIG. 1 for initiation of a conference call per the information collected per FIG. 2;

FIG. 5 is a representation of the display screen of a remote computer during a conference call showing various options for input of adjunct data offered during a conference call;

FIG. 6 is a data flow diagram of the audio and adjunct data received at the server of FIG. 1 from users of the remote computers and adjunct data received from a real time analysis engine also receiving the data from the users;

FIG. 7 is a pictorial representation of an audio data stream as tagged by the adjunct information from the users and the real time analysis engine of FIG. 6;

FIG. 8 is a representation of a database record for storing adjunct information related to user-entered adjunct data in the form of text notes or pre-prepared documents;

FIG. 9 is a figure similar to that of FIG. 8 showing storage of accessed tag types;

FIG. 10 is a figure similar to that of FIGS. 8 and 9 showing storage of adjunct information from a real time analysis engine;

FIG. 11 is a diagram of a standardized data file incorporating the audio data stream and the adjunct information for multidimensional access to the information of the conference call;

FIG. 12 is a diagram of a screen display on a remote terminal operating to review the standardized data file of FIG. 11 showing various searching and indexing options including a tag list showing a sorted listing of adjunct information;

FIG. 13 is an expanded fragmentary view of the tag list of FIG. 12 showing a pre-prepared outline that may be used for the generation of adjunct information;

FIG. 14 is a flowchart of a viewer program implementing the screen display of FIG. 12;

FIG. 15 is a data flow diagram the process of publishing the standardized data file in various versions;

FIG. 16 is an alternative screen display to that of FIG. 5 during a conference call linking the generation of adjunct information to talking point outputs to the user for the guidance of the conversation;

FIG. 17 is a data file providing a linkage between tag data to talking points; and

FIG. 18 is a representation of the multidimensional indexing of audio stream data provided by the present invention.

### DETAILED DESCRIPTION OF THE PREFERRED EMBODIMENT

### Hardware

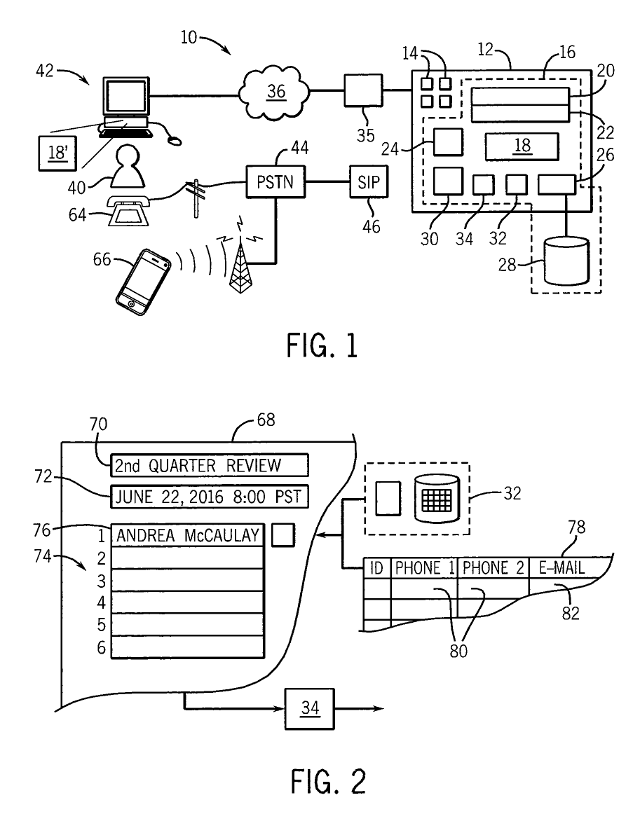

Referring now to FIG. 1, a telephone conference system 10 of the present invention may include a computer server 12 having multiple processors 14 communicating with a memory system 16 (including generally random access memory, disk storage, as well as online storage and cloud services).

The memory system 16 may hold a variety of executable programs including an operating system 20, for example Ubuntu Linux, available and described at http://www.ubuntu.com/ and a virtualizer 22 such as Kernel-based Virtual Machine (KVM) available and described at http://www.linux-kvm.org to create multiple virtual machines as is generally understood in the art. Each of the virtual machines may execute additional programs held in memory system 16 including server software 24 such as the Apache server available and described at http://www.apache.org providing standard web and other server functionality, a database program 26 such as PostgreSQL available and described at http://www.postgresql.org communicating with a database record 28 and providing indexable and searchable data structures. A telephone system interface 30 such as FreeSwitch available and described at http://www.freeswitch.org may provide for a telephony platform allowing the routing of audio text and other media.

As is generally understood in the art, server software provides communication over the Internet with multiple browser programs and may serve applications and data from the telephone conference system 10. The database program 26 may manage data to be readily searched and updated typically by storage of a structure of records having fields. The telephone system interface 30 provides an interface between the computer server 12 and a standard telephone network.

The memory system 16 may further hold a customer relationship management (CRM) program 32 providing a method of storing and retrieving customer contact information, for example, as are commercially available under the trade names of: Salesforce, commercially available from Salesforce.com, Inc. (http://www.salesforce.com); or CRM-On-Demand commercially available Oracle Corporation (http://www.oracle.com); or Microsoft Dynamics commercially available from the Microsoft Corporation (http://www.microsoft.com). Finally, the memory system 16 may run an e-mail program 34 for sending and receiving e-mail such as the Outlook program also from the Microsoft Corporation described above. It will be understood that each of these programs may be a freestanding programs on one or on multiple computers inter-communicating via a network and suitable application programmer interfaces, or may be integrated into a single or multiple programs.

The computer server 12 may communicate through standard electrical interfaces (e.g. Ethernet cards) with a firewall 35, for example a high-availability firewall available from Fortigate, Inc. (http://www.fortinet.com). The firewall 35 may be connected through the Internet 36 with remote users 40 via remote terminals 42 associated with each of the users 40.

Referring momentarily to FIG. 3, generally each terminal 42 may be a standard desktop personal computer including a processor system 48 holding one or more processors 50 communicating with a memory 52. Memory 52 may hold, for example, a standard operating system 54 such as the Microsoft Windows operating system from the Microsoft Corporation referenced above. The memory 52 may also hold a browser 56 such as the Firefox browser available from and described at http://www.mozilla.org and further may hold possibly a program portion 18′ of the program of the present invention preloaded or downloaded from the computer server 12. The processor system 48 may communicate with a graphics terminal 55, a keyboard/mouse 57, an Internet connection 58, a microphone 60 and/or a web camera 62, all generally understood in the art.

Referring again to FIG. 1, the computer server 12 may also communicate with the public switched telephone network (PSTN) 44 via a SIP Trunking system 46, provided by one of multiple commercial inventors as is generally understood to those of ordinary skill in this art. The PSTN 44 may communicate with a given user 40 via a standard landline telephone 64 or a cellular telephone 66 accessible to the user 40 when operating the terminal 42.

### Software and Operation

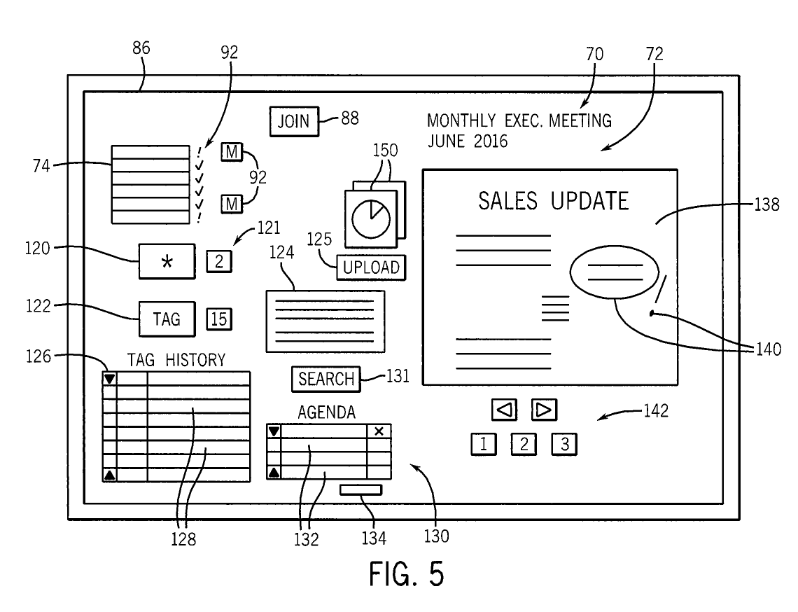

Referring now to FIGS. 2, and 5, a conference call may be initiated by a user 40 executing the program 18 to invoke a setup menu 68 per process block 71 as part of a conference call setup process. The setup menu 68 may solicit a conference call title 70 and (in the event that the conference is not a post hoc conference) a conference time 72 including a day, time and time zone. In addition, identification of the desired participants in the conference call may be entered into a participant list 74 as represented by participant screen names 76.

Entry of the call participants' identification into the participant list 74 may be performed by linking to a CRM program 32 holding a list of potential call participants and usable to automatically populate a data file 78 accessible by the program 18, with details about the call participants including: a participant screen name 76, a first and alternative phone number 80 at which the participant may be reached, and an e-mail address 82 for contacting the participant. Alternatively this information may be manually entered into the data file 78 by the user 40 setting up the conference call. The invention contemplates further that a conference participant may be designated solely via telephone number without necessarily identifying the individual or using a link between an individual and that telephone number (particularly useful if the telephone number is temporary).

Upon completion of entry of the setup information, if the conference is a post hoc, the call participants are contacted as described below. For a scheduled conference, however, the program 18 may automatically schedule the time of the conference call with the conference call participants, for example, using the e-mail program 34 to send e-mail schedule reminders to those participants to check their schedules in case of conflict, or may provides automatic scheduling per standard features with many e-mail and calendar programs. Scheduling failures or problems with scheduling may be reported back to the user 40 scheduling the conference, according to conventional e-mails channels or via the program 18. In this regard, the scheduling e-mail may refer the call participants to a website allowing collection of information with respect to availability being a portion of the program 18.

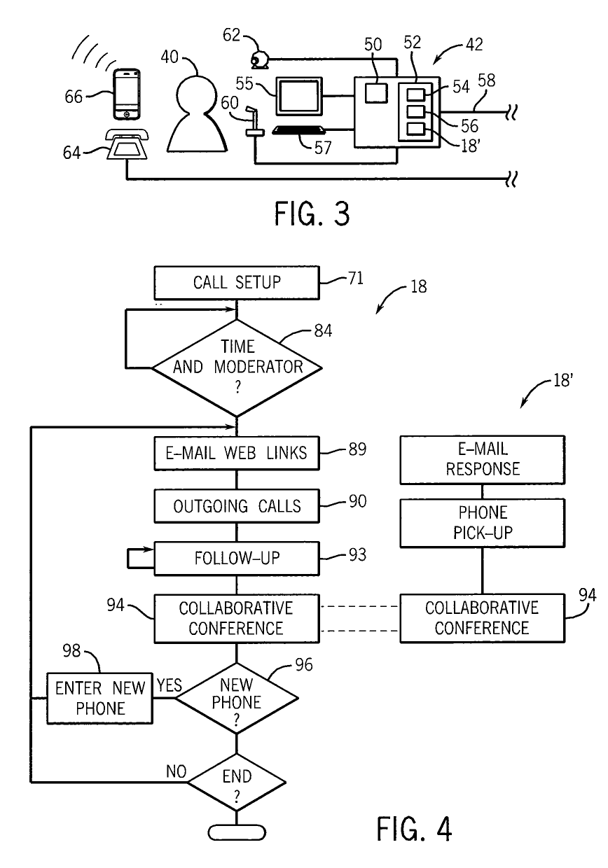

Referring now also to FIG. 4, once the conference call is scheduled, the program 18 monitors the current time as a background task as indicated by process block 84. At a predetermined reminder time that may be adjusted by the user 40 (for example 15 minutes to five minutes before the scheduled conference time 72) the program 18 opens a conference window 86 on the user's browser (shown in FIG. 5) providing a connection to the computer server 12 for a conference session executed on one of the virtual machines. The program 18 in the terminal 42 may initiate a Web server session associated with the particular conference call according to the data previously entered. Optionally, and not shown, an additional password may be required. The conference window may be implemented using standard Web communication protocols to appear to the browser like a standard webpage albeit with dynamically generated information.

The conference window 86 may include a join button 88 allowing the users 40 to enter the Internet portion of the conference. In addition, the presence of the moderator may be determined either by the moderator entering an additional PIN (personal identification number) number into an appropriate text box (not shown) or as may be inferred from the moderator “dialing out” to themselves from the application while logged in At process block 84 when the conference time and the moderator are present, ensuring that the conference is likely to occur, the program 18 may send e-mails to the other conference participants with links to an address of the conference window 86 for that conference dynamically generated by the computer server 12. The e-mails may be sent to each of the other participants of the participant list 74 as indicated by process block 89. One of the e-mails may also go to the conference moderator in the event the moderator is not at the computer terminal 42 used to set up the conference.

Each of the e-mails, in addition to including a link associated with a conference window 86 for the scheduled conference call, may provide reminders to the participants to upload necessary conference materials to the computer server 12 prior to the start of the conference and instructions for doing so. This uploading process may, for example, employ a contained FTP client associated with the browser. Uploading may also occur after the conference has started for example by using an upload button 125.

As noted, participants may depress corresponding join buttons 88 each providing a signal as indicated by process block 89 to the computer server 12 that they have joined the portion of the conference call conducted via the internet 36 as will be described. Alternatively, participants may be automatically joined to the conference by the activation of the application on their terminals 42 as each application automatically navigates to the necessary web link.

As indicated by process block 90, computer server 12 may process the data from the participant list 74 and initiate outgoing calls through the PSTN 44 to the phone numbers 80 previously entered, starting with the primary phone number of each conference call participant and then, at process block 93, if no response is obtained, moving to the follow-up numbers 80. A manual procedure for dialing participants may also be provided or a call in number for conventional joining of individuals to the conference.

When the participants answer the phone establishing a connection, as indicated by process block 91, this fact may be communicated to the computer server 12 and displayed in the conference window 86. In this regard, the conference window 86 may display the participant list 74 together with an icon 92 indicating the status of the connection of each participant on the PSTN 44 and via the Internet 36. For example, a check mark may indicate that the participant is fully connected on the PSTN 44 and the Internet 36. Lack of full connection may be indicated by an exclamation point leading to a pop-up window detailing the particular missing elements. The participant list 74 may be associated with mute buttons 93 allowing selective muting of voice data from that participant to other participants.

As indicated by process blocks 94, the collaborative conference process may then begin in which each conference participant may exchange information by voice over the phone line and information over the Internet by text, images, and documents and other data as will be further described below.

During the conference call it may be necessary for one or more participants to leave the conference and/or reconnect over a new phone number. This possibility may be detected by decision block 96 responding, for example, to a re-pressing of the join button 88 by that participant, this action allowing the departing participant to enter a new phone number and/or e-mail address as indicated by process block 98 together with a short delay period. The program 18 may then resend the e-mail web link for the conference and redial the new telephone number for this participant allowing them to connect at a different location. This feature may also be used by the moderator for participants who are not at their previously identified phone numbers where a new number needs to be entered. The system also contemplates mixed connection in which some conference participants call in per a conventional conference call and provide a conference ID and password that may be available in the initial e-mails forwarded to the conference participants according the instructions entered at the time of set up.

The invention also contemplates that new parties may be added at any time by a similar procedure either by manually entering their telephone numbers for a call out or by sending them by any means a conference number and conference identification number per a conventional conference call.

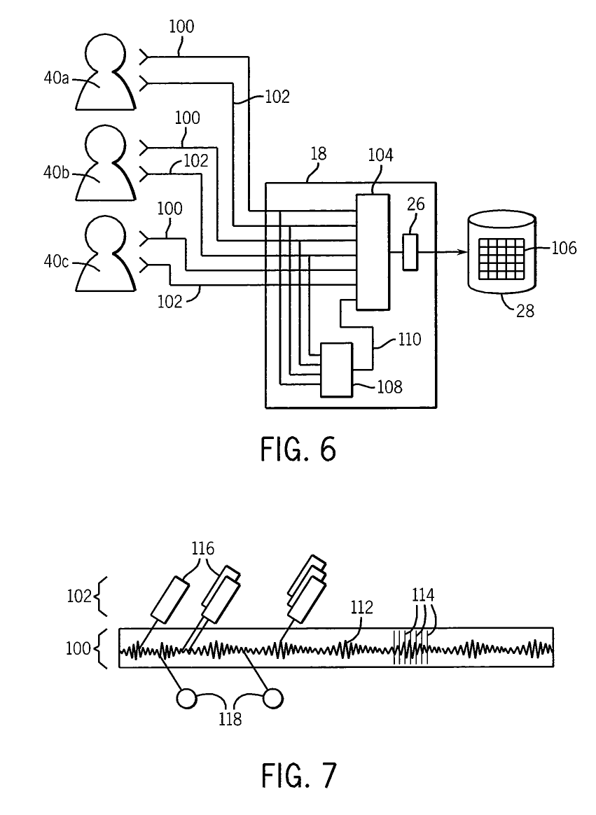

Referring now to FIGS. 5 and 6, during the conference call, each user 40a-40c (limited to three in this figure only for clarity) may generate an audio data stream 100 via the PSTN 44 in the manner of a conventional conference call and may also generate adjunct data 102 entered via their terminal 42. In connection with this preferred embodiment, it is possible to designate any one of the various “users” as the “host” and that status may change during the duration of the call. The distinction between a “user” and one who is designated a “host” is one of control over the dashboard and any associated documentation. As will be discussed in more detail below, the adjunct information to be added by a user may include various tags invoked during the conference including text, verbal comments, display events related to shared documents and annotation of those documents, or screen “button presses” providing pre-defined tag texts or actions. This data stream from each user 40 may be received separately over the Internet 36 and the PSTN 44 and digitally combined by the program 18 by a file former 104 and stored by the database program 26 in a database compatible conference call record 106 containing multiple data types. The audio data stream 100 from each user 40 may also be automatically analyzed by a voice analysis engine 108 generating additional machine adjunct data 110 provided to the file former 104 to be added to the conference call record 106. The voice analysis engine 108 may also receive adjunct data 102 for assistance in interpreting the voice data. For example, the voice analysis engine may be programmed to identify specific word patterns (such as “follow up” or other common phrases employed by those on a conference call) and generate specific tags associated with the detected term(s). The voice analysis engine may be programmed to learn the speech patterns of call participants so their respective contributions can automatically be flagged. The voice analysis engine may further be programmed by software that is capable of recognizing stress levels in a participant's voice (such as the stress monitor module described in U.S. Pat. No. 7,151,826 or one of similar ilk) and include tags or other auto-generated information at such a point in the discussion.

Referring generally to FIG. 7, it will be understood that the audio data stream 100 will generally comprise for each user a series of sampled audio data values 112 digitized at a sample rate linked to a clock index value 114, the latter generally providing a value indicating the time since the beginning of the conference of any given sample of the audio data values 112 and thereby providing an index for the audio data values 112. This clock index value 114 may be further associated with each of the set of manual tags 116 that are generated from the adjunct data 102 as will be described and machine tags 118 generated from the machine adjunct data 110. In this way the clock index value 114 may allow connection of given audio data values 112 to the manual tags 116 and the machine tags 118 which provide alternative dimensions of indexing of the audio data values 112. The conference call record 106 may preserve each of the audio data values 112 and tags 116 and 118 separately for each user 40 or the voice analysis engine 108.

Referring now to FIG. 5, the adjunct data 102 generally entered through the conference window 86 may be generated in a variety of different ways amenable to use during a conference in real time. A primary generation technique may be pressing an “important” button 120 in the conference window 86 which causes the generation of a tag 116 on the audio data values 112 at the point the button is pressed designating the particular points raised in the conversation of the conference call as important. Each so generated tag maybe linked to the particular individual pressing the button to record items in the call that they may wish to review in the future, or, if this information is marked public, to reveal the attitude of different participants in the conference to any individual participant. Optionally, the other participants, when the important button 120 is pressed by any participant, the important buttons 120 of the other participants may glow briefly allowing them to also press it and thereby add their votes (indicated by vote indicator 121) to the importance of that particular point. In this respect, the wisdom of the group is also elicited by pressing of the important button 120. Significantly, the important button 120 takes very little effort by the participant and thus does not unduly inhibit the free flow of ideas in a real-time conference call. The amount of time a vote remains open may be unlimited during the entire conference and individuals may change their votes, for example, in response to other votes. Alternatively, a limited time may be allowed for voting.

Additionally, the participants may press a tag button 122 providing a wider variety of different tags. The tag button 122, for example, may open a menu allowing selection of multiple different types of pre-authored tags that have been pre-generated as being typically useful. Such tags may include “to do”, “concern”, “important”,“follow-up”, “verify”, “review”, “contact”, or “custom note”. These tags may not be transmitted to the other participants at the election of the user applying them and may simply be identified to the user making the selection. The “custom note” tag opens an editor window 124 to allow text entry by the participant of an arbitrary text note. Each of these latter tags including the custom note tag may be assigned a privilege level as: public, that is visible to all other users, or private, that is visible only to the person entering the note text, or a variation of “semi-private” where the text is shared with some but not all participants (for example, in a negotiation or similar setting, the note may be transmitted only to the user's fellow team members and not the other participants).

In one alternative, the participant may enter a spoken note via a microphone 60 or through the telephone 64 temporarily muted from the other users.

The time of entry of each of these tags is recorded so that the tag may be related to a portion of the audio track of the telephone conference.

The participant may alternatively or in addition have a set of uncommitted pre-authored tags that may be loaded into an agenda window 130, for example, each tag representing an agenda item 132 and not yet linked to the audio data stream 100. During the telephone conference, the agenda window 130 allows the user to connect agenda items to points in the audio data stream 100 with a single action when those agenda items are discussed. The agenda may be uploaded using an upload button 134 during or prior to the meeting, for example, at the time of receipt of the reminder e-mail. It will be appreciated that the agenda need not be an agenda per se, but can, for example, be a proposed outline of the meeting, list of talking points or the like.

On a real-time basis, each of the entered tags 116 or 118 may be displayed on a tag history 126 providing on the conference window 86 in tabular form, a brief summary 128 of the tag (for example its name or one sentence from a text note) and allowing the tags 116 and 118 to be searched for and sorted, for example, using a search button 131 during the call to review previous text notes. The searching process may also allow playback of different previously recorded portions of the telephone conference during the telephone conference as accessed by a particular tag so that the call may in fact incorporate its own previously recorded portions allowing the conference call participants to review portions of the conference call even as it is conducted. Several important search modes include the ability to filter tags for a particular individual or group of individuals (e.g. just show all tags by Persons A and B) or to filter tags for type (e.g. just show all tags of “important”) or to filter tags according to agreement in voting (e.g. just show an ordered list of votes having a threshold of agreement (e.g. greater than 50 percent)).

The conference window 86 may also provide for an electronic whiteboard 138 allowing display to all participants materials previously uploaded to the computer server 12, for example, PowerPoint presentations, photographs, graphics, video, slides or the like, for display. The whiteboard 38 may allow the users to annotate the display with annotation marks 140 using, for example, a cursor control device such as a mouse or the like. In this regard, the whiteboard 38 may be used as a sketchpad without an underlying document. The whiteboard 138 may be associated with controls 142 allowing the “owner” of the displayed material (being the person who uploaded it) or “host” to navigate through those materials. Display of material on the whiteboard 138, changing the display using controls 142, and annotation of the display with annotation marks 140, each generate automatic tags 116 associated with a particular user and providing a pointer to the underlying file. A given user may upload multiple documents which may be displayed in thumbnails 150 for convenience during the conference call to be dragged and dropped to the whiteboard 138 as desired.

The conference window 86 may further provide for a conference call title 70 and the conference time 72 for the benefit of the participants, such as was previously entered during the setup process.

Referring momentarily again to FIGS. 6 and 7, machine tags 118 may be generated by the voice analysis engine 108 monitoring the audio data stream 100 or the adjunct data 102 or other data entered by the users 40, for example, during the call setup. In addition, machine tags 118 may be generated from data derivable from the receipt of the adjunct data 102 and audio data stream 100 over the Internet 36 or the PSTN 44 alone or in combination. Examples of such machine tags 118 include identification of a particular speaker when the speaker changes, identification of certain words occurring in the audio data stream 100, for example, as determined by audio transcription techniques, identification of non-spoken audio cues including exclamations and laughter, identification of emotional characteristics of the speaker revealed from the speaker's voice, for example, indicating an excitement or interest level, as well as identification of gender, accent or the like.

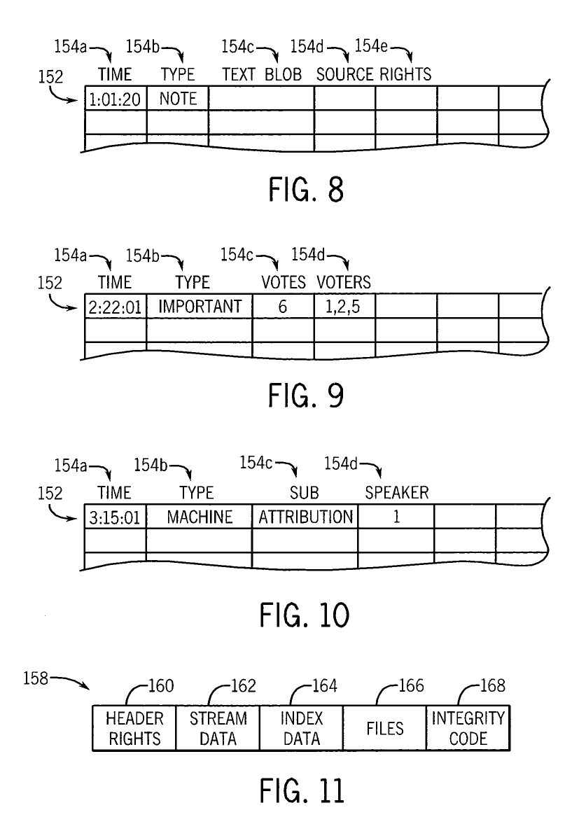

Referring now to FIGS. 8, 9, and 10, each tag 116 and 118 may be represented in the conference call record 106 as a separate record 152 in the database records 28, each record 152 having a first record field 154a indicating elapsed time of the clock index value 114 to which the tag 116, 118 is associated. A subsequent field 154b may indicate a type of the tag, for example, a custom text note as indicated. This field 154b will influence the next columns or fields 154c which, for a custom text note, may include generally a text binary large object (BLOB) indicating text of the custom text note. The next field 154d may indicate the source of the note (e.g., the user 40), and in field 154e the rights or privileges to review the note (e.g., if it is shared or public) and other similar data. It should be understood that these representations are intended simply to depict the logical components of the data used in the invention rather than a particular schema of the database and that the invention is not tied to a particular implementation of a database or the distribution of data among files and records and tables of one or more databases.

Referring to FIG. 9, in a second example a record 152 associated with the “important” button 120 (shown in FIG. 5) may provide an “important” type per field 154b. This type provides for field 154c indicating the number of votes for the tag and field 154d indicating the particular persons voting.

Referring now to FIG. 10, an example machine tag 118 may be represented by a record 152 indicating as a type in field 154b a “machine” type and a subtype in field 154c of an “attribution”, for example, identifying the particular speaker at that time in the audio record in field 154d.

It will be understood that each of the above tag types may have corresponding records 152 with different fields 154 as may be appropriate. For tags generated automatically from the whiteboard 138, the tag will typically include a pointer to the underlying document being displayed on the whiteboard 138 as well as multiple image files (JPEG or MPEG) providing records of the annotations to the document implemented during the conference call.

Referring now to FIG. 11, the information of the conference call record 106 and the audio data values 112 may be combined in an audio markup file 158 that may be stored or transmitted to the participants or other individuals for subsequent review or which may be served on a server to those who wish to review the contents of the conference call. Generally the audio markup file 158 will include a header 160 providing basic information about the conference call including, for example, the time of recording, the particular equipment and phone numbers involved, the persons being recorded, countries of the IP connections and the like. Importantly the header 160 may also designate a particular privilege level for the document so that different users 40 may see different portions of the document as will be described further below. Following the header 160 may be the stream data 162, for example, the audio data values 112 associated with the clock index value 114 either expressly recorded or implicit in a known or recorded sampling rate.

Following the stream data 162 is indexed adjunct data 164 provided from the conference call record 106, organized in a retrievable fashion, for example, as comma delimited text or the like. The storage of the indexed adjunct data 164 is such that it can be reconstructed into a database and used for rapid indexing of the stream data 162 as will be described below. Particular document files 166, for example, forming the basis of a presentation on the whiteboard 138 may be incorporated into the audio markup file 158 so that the conference call may be completely reconstructed from the data stored in the audio markup file 158.

A footer to the audio markup file 158 may provide integrity codes 168, for example, being a “watermark” and one or more error correcting codes for the data of the audio markup file 158. Integrity codes 168 may prevent undetected alteration of the conference call and thus may provide for strong evidence of the call's contents at a later date.

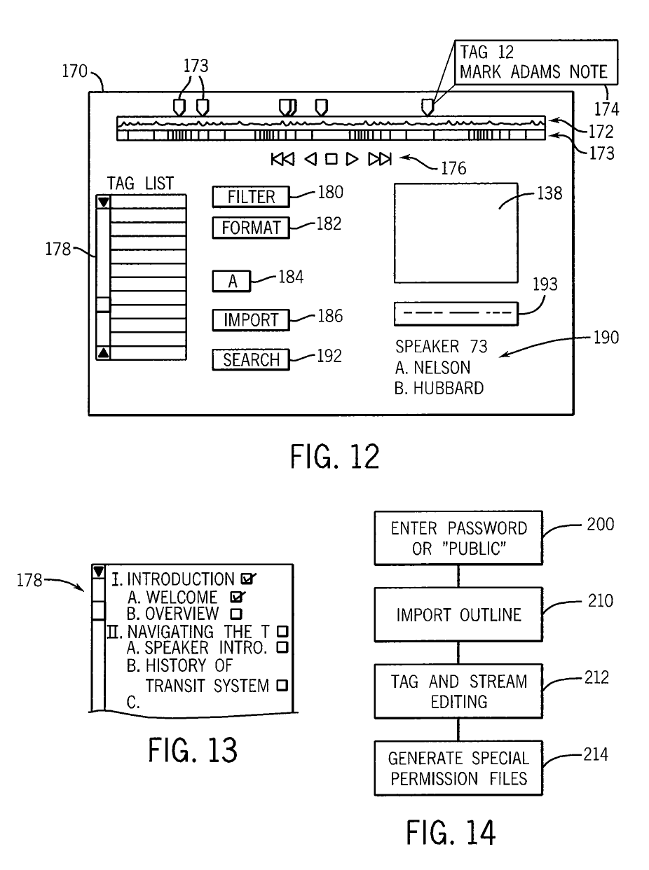

Referring now to FIG. 12, the audio markup file 158 may be reviewed and modified using the program 18 and a set of displays and controls visible through an editor screen 170 that may be displayed on a terminal 42 or the like. The editor screen 170 may provide for a linear representation 172 of the audio data stream 100 with a horizontal time axis, for example, in the form of a horizontal bar depicting a time function of the audio data values 112 as shown in FIG. 7. Positioned above the linear representation 172 may be particular tag icons 173 indicating the location of the tag within that linear audio file. Each tag icon 173 may reveal by its shape or color the type of tag and may provide more detailed information in a pop-up window 174 invoked by clicking on or hovering over the particular tag icon 173. Double clicking on the tag icon 173, for example, may take the user to a short segment of the audio data values 112, beginning a predetermined number seconds before the tag (e.g. 15) and continuing thereon.

A set of standard audio controls 176 may be placed under the linear representation 172 to allow conventional review of the audio data values 112 in the manner of a tape recorder. During any playing of the audio data values 112 of the linear representation 172, whiteboard activity may be displayed on a comparable whiteboard 138 and recorded tags 116 or 118 may be highlighted in a tag list 178.

The tag list 178 provides a tabular listing of all tags associated with the conference call being edited similar to that shown in FIG. 5. The tag list 178 lists relevant summary information of all the tags 116, 118 in a scrollable menu. Again clicking on a particular tag in the tag list 178 brings up a pop-up window (not shown) providing additional information about that tag. Double clicking on a particular tag in the tag list 178 takes the user to a short segment of audio data values 112 associated with the a tag in the same manner as the tag icons 173.

In addition, the listing of the tags in the tag list 178 may be filtered (for example by any of the tag attributes, for example, type of tag, speaker, etc.) using a filter dialog (not shown) invoked by a filter button 180. The filtering may include those filter characteristics discussed above with respect to search button 131. A format button 182 allows formatting of the tag list, for example, in an outline form (for example with outline numbers, indentation, font changes and the like) when the editor is later used simply as a way to playback review the conference call without editing per se. This is the default mode of the editor of an audio markup file 158 with public rights. In this context, a formatted tag list may provide bookmarks outlined for navigating through the conference call materials without allowing editing.

The searching process itself may be used to further add machine tags 118 to the data of the audio markup file 158 however stored. Thus, for example, a tag may indicate that a specific portion of the audio was reviewed more than other portions of the audio (or how much it was reviewed), and can then mark this fact or simply tag it as as important based on the inference that multiple reviews equate to importance. In addition or alternatively the search terms of the search may form the basis of a machine tag added to the file, for example, globally.

When editing is to be allowed, for example, if the permission level of the header 160 of the audio markup file 158 is to a participant or the conference moderator, an annotation button 184 may be presented to the user to annotate the audio markup file 158 in any of the ways that could have been done during the conference call in real time and as described in the discussion associated with FIG. 5. Annotation in this case, includes erasing of tags 116 or adding of new tags 116. All such annotations are marked as to the date of annotation to be clearly distinguishable from the original conference call.

An import button 186 allows the user to import an agenda or outline into the tag list 178 to facilitate creating an index or the like on an annual basis. Referring momentarily to FIG. 13, this agenda or outline may be imported into the tag list 178 and used, for example, by an individual reviewing the audio data stream 100 to tag particular sections of an outline or agenda as they are discussed in the conference as reviewed during the editing process as opposed to when the conference call is occurring.

Some types of discrete machine tags 118, for example speaker attribution and voice revealed emotion, may be displayed in a machine tag box 190 providing additional information to someone reviewing the audio markup file 158 in the editor as a reader. In addition, text captioning may be provided, for example, under the whiteboard 138 on the editor screen 170 at a caption block 193, the captioning provided by a speech recognition engine processing the stream data 162 of the audio markup file 158. Alternatively, the captioning may occur during the conference call and recorded in the audio markup file 158. The voice analysis engine 108, discussed with respect to FIG. 6, may also be used on the recorded audio stream data 162 to process the audio markup file 158 to provide additional information to the reviewer that was not necessarily obtained at the time the conference generated. In this regard, the voice analysis engine 108 may prepare other data streams that can be displayed, for example, in a linear representation 172 as a continuous variable, for example revealing voice agitation. This continuous variable may be displayed, for example, in colors or shade values ranging between the limits of the value (e.g. unagitated and agitated).

Importantly, the editor screen 170 provides for a search button 192 allowing multidimensional access and searching of the substantially linear data of this audio data stream 100, for example, using not only time but any of the dimensions provided by the particular tags 116 or 118.

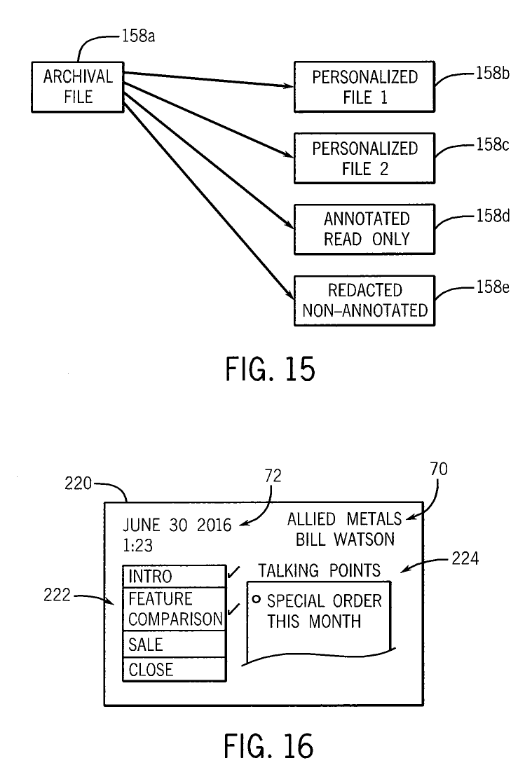

Referring momentarily to FIG. 15, an archival audio markup file 158a may be generated by the conference moderator or a proxy designated by the conference moderator and the controls of the editor screen 170 (not shown) used to generate and save (in the manner of a conventional digital file) multiple custom audio markup files 158b-158e having different permissions and different content. For example, a first version of audio markup file 158b may be personalized to a particular individual, this version of the audio markup file 158b displaying all public tags but only private tags 116 of a participant linked to the personalization and recorded in the file header 160 (shown in FIG. 11). Such an audio markup file 158b would thus not reveal tags of another individual, for example, subject to being displayed in second audio markup file 158c associated with that other individual. In addition, annotated audio markup file 158d may be created having an added index for easy access. Such a file may be, for example, marked read-only, a status preserved by the integrity codes 168 and allowing it to be viewed without changing in the editor screen 170. Alternatively or in addition, a redacted audio markup file 158e may be generated, the redacted audio markup file 158e removing tags 118 and 116 and portions of the audio data stream 100 not relevant to public reviewers. Each of these audio notation markup files 158 has the relevant limitations and audience recorded in the header 160 discussed with respect to FIG. 11.

It will be appreciated, that the data of the archival audio markup file 158 may alternatively simply be retained in the database where it is originally stored and that retrieval filtering and sorting of the information may be obtained using the mechanisms of the database for superior access speed. Likewise the archival audio markup file 158 may be reconstituted into a database format for access.

Referring now to FIG. 14, the reviewing process of editor screen 170 may begin as indicated by process block 200 with identification of the user of the editor or the default public value which may be matched to the header 160. Generally the user of the editor will only have access to public information and information that the user personally generated with the exception of the moderator or the moderator's proxy who may have global access to all information of the audio markup file 158. At process block 210, the user may upload an index or the like used to provide improved structure for reviewing the file. At process block 212, the user may annotate any of the tags using the annotation button 184 described above. This annotation process may add, for example, tags 116 to the audio data values 112 based on the uploaded outline and equally may remove tags 116 and 118 and even portions of the audio data values 112.

At process block 214, the header 160 may be adjusted to limit the rights to this file of particular viewers, for example, and optionally as linked to a password or the like for the process described generally with respect to FIG. 15.

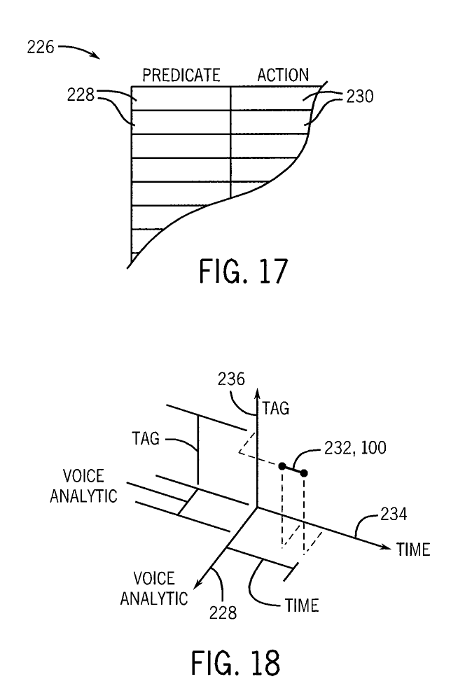

Referring now to FIG. 16, the present invention is not limited simply to multiparty business conferences but any conference in which as few as two individuals participate. In one useful extension of the invention, the invention may be applied, for example, to one-on-one business conversations, for example, a sales call. In this case, a specialized call screen 220 may be provided in lieu of conference window 86, the call screen 220 having, for example, the familiar conference time 72 and a conference call title 70 but providing very specialized tag buttons 222, for example, that indicate particular goals or agenda items to be accomplished during the call. For example, during a sale call, the salesperson may be encouraged to attain certain milestones during the call such as an introduction, a feature comparison of products, a request for sale, and a close. Reaching of these milestones may be suggested, for example, by the voice analysis engine 108 monitoring transcribed words of the call or the like which may cause a highlighting of the particular milestone button 222. If the salesperson then activates the milestone button 222, this action may be used to drive a display of special talking points 224 or the like which may provide for useful information in the form of proposed text or questions or may call up documents or the like. Referring now to FIG. 17, the talking points 224 may be generated by a talking point table 226 prepared prior to the call listing predicate conditions 228, for example pressings of milestones buttons 222 and the occurrence of machine tags 118. These predicate conditions 228 may be associated with actions 230, for example the generation of talking points for the calling of documents or the like.

This tag data and the associated audio stream may be automatically or semiautomatically added to a customer CRM database, for example, to record salient facts about a transaction with that customer including promises, terms, and warranties covered during an audio conversation. These tags may be entered by manually pressing dynamically updated or static milestone buttons 222 or by speech recognition techniques looking for terms such as “delivery”, “guarantee”, “schedule” and the like associated with these topics. This speech recognition may likewise invoke the necessary milestones buttons 222 for manual confirmation.

Referring now to FIG. 18, it will be appreciated that the present invention provides a mapping of the generally one-dimensional audio stream portions 232, being part of a one-dimensional audio data stream 100 having a one-dimensional index variable of time indicated by axis 234, to multi-dimensions of index variables. For example, the audio data stream 100 may also be indexed in the orthogonal dimensions of a tag axis 236 or the voice analytics axis 238. What this means is that isolating a particular audio stream portion 232 may be performed more rapidly than would be required by simply moving through the audio file in time-wise fashion in the manner of a tape recording.

It will be further appreciated that the annotation of an audio file provided by the present invention provides machine-readable indexing for rapid searching and review not only of a single audio file but also across multiple audio files. Thus, for example, a search may be conducted over the annotated audio files representing multiple conference calls or similar recordings to extract all portions of these conference calls related to a particular matter as tagged.

The present invention, of course, contemplates more than three easily depicted dimensions and allows particular audio stream portion 232 to be sorted and searched via multiple of such axes simultaneously permitting searches or sourcing by logical or mathematical combinations of different dimensions (e.g. searching for “important” tags where voice analytics also confirm interest by the participants of above a particular threshold, after the first five minutes of the meeting).

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. For example, the description of embodiments refers to “conference call.” It is intended that any discussion between or among at least two persons be included in the broad sense of conference. Thus, it is envisioned that a lecture may be embraced within the ambit of “conference” where a lecturer and an audience member may benefit from the structure and function of the present invention as might be implemented by the audience member adding tags and or notes via a tablet or smartphone to the audio stream of the lecturer that is recorded for later search and retrieval. Thus, conference should be as broadly interpreted as the prior art permits. In like vein, the term “call” should not be narrowly confined to a conventional telephone call. Participants in a conference may be joined in any of a number of ways. The functional requirement is that call participants who are generating the audio stream have the capacity to add to that stream or to add search-identifying indicia to that stream. Indeed, even the term “participant” should be interpreted broadly to include those who engage in the real-time creation of the audio stream, who are present on the “call” while that stream is being created or who access the stream at a later time and add tags, notes, comments or other search-identifying indicia not in real time. The specification often refers to “adjunct data” or other similar terms. These too should be interpreted broadly to include but not be limited to tags or other forms of metadata; once again, these should be considered functionally to be the addition of any indicia allowing for the association of the voice stream with information of interest and can facilitate searching such as nonlinear searching of the audio stream. These and other similar terms used in the conventional or vernacular should not be deemed limitations unless those limitations are imposed by the prior art. All of the publications described herein, including patents and non-patent publications are hereby incorporated herein by reference in their entireties.

### Appendix Listing of Machine Tags 118

1. Creation Metadata
Time of recording
Time of import into the system
Method of import, e.g. upload from cell phone, database, on-line service
Person(s) being recorded
Geography/country (optionally derived from IP or phone number)
Default language of recording
Links to invitation, account or originating request facilitating the recording

2. Images—in jpg, png, gif and eventually svg
tied to a specific moment in the audio
tied to a range of time in the audio
where a photographs are uploaded from the camera of a mobile phone
where an image is uploaded from an on-line stock photography index
where a reference to an image from an on-line image service is used

3. Presentation—such as Microsoft PowerPoint or LibreOffice Impress
including page numbers tied to specific moments in the audio
including page numbers tied to ranges of time in the audio
where a reference to a hosted presentation is used in an on-line repository (e.g. Google Apps or Scribd.)
where text is extracted from the presentation to be used for markup
Where an agenda is extracted from the presentation for markup

4. Machine Transcription
Where a machine transcription service has provide an MRCP2 or similar file
Where confidence levels are captured on a per word or per sentence basis
Where an index is generated such that phonetic search is possible, not just text search
Where words and sentences are linked to specific time ranges of the audio
Where effort is made to distinguish known speakers and link audio to who is speaking
Where mathematical techniques are used to estimate the number of speakers
Where audio is grouped by speaker by sound without prior knowledge of identity
Where multiple services are used to aggregate a plurality of transcriptions
Where translation from one language to another is performed along with transcription
Where the transcription software vendor, version and date of transcription are captured

5. Human Transcription
Where machine transcription is presented to a human for correction or formatting
Where a plurality of transcriptions are provided allowing a human to select the best
Where a human is asked to assess the quality of transcription for quality assurance

6. Notes/Comments
Where text is captured in real time during the recording and is tagged to a moment
Where text is captured in real time during the recording and is tagged to a range
Where text is later added or edited by participants or others
Where text is searchable to retrieve related notes, timeline, or audio
Where text is condensed into a summary of the event
Where text is ranked or rated to gauge their significance in real time
Where text is ranked or rated to effect its prioritization in a compiled summary

7. Usage
Playback Listeners (IP/Date/time/playback device)
Person Originating of Sharing invitations
Sharing invitations issued/consummated
Comments of sharing participants

8. Inflection
Quantitative Strength of accent
Qualitative type of accent/dialect
Base language
Geography of accent region
Emotional tone in the audio (both Average and extremes)
Amplitude of the audio—e.g. is it loud enough?
Quantitative analysis of Background noise—is it from a noisy location?
Quantitative Pauses in the audio—is the speaker pausing or talking non-stop.
Beginning and Trailing silence—is the speaker possibly being cut-off?
Quantitative evaluation of Compression artifacts and/or type of compression
Average Frequency of speaker (e.g. high/low)
Quantitative analysis of gender.
“Raspishness” of speaker—e.g. ratio of ‘sshh’ and whispering sounds to normal Laughter

We claim:

1. A telephone conference call system comprising:
an electronic computer executing a stored program held in non-transient media and communicating electronically with a public switched telephone network, the electronic computer executing the stored program to:
(a) identify a set of conference call participants and telephone numbers;
(b) at a time of the conference call, initiate calls to the call participants;
(c) upon pickup of the computer initiated calls by the call participants, joining the call participants together in a conference call.

2. The conference call system of claim 1 further including the step of e-mailing to the conference call participants a web address providing for intercommunication between the conference call participants over the web.

3. The conference call system of claim 1 further including multiple numbers for call participants including the step of moving through the telephone numbers after a predetermined period of time if call participants do not pick up.

4. The conference call system of claim 1 further including receiving instruction from at least one call participant joined together in the call for a change in telephone numbers to a new telephone number and initiating a call to the one call participant on the new telephone number to join the one call participant together in the conference call.

5. A method of improving the accessibility of recorded telephone conversations among individuals participating in a telephone call using at least one electronic computer executing a program stored in non-transient media to execute the steps of:
(a) receiving from one or more telephones associated with the individuals an audio stream of sampled audio data associated with time values;
(b) receiving adjunct data related to the audio stream and associated with the time values;
(c) recording the audio stream and adjunct data linked through the time values to the audio data; and
(d) accepting a search request from an individual for a portion of the audio stream related to either or both of dimensions of time value and adjunct data to output a portion of the audio stream related to the time value or adjunct data.

6. The method of claim 5 wherein the adjunct data is received over the Internet from the individuals during a receipt of the audio stream from the telephone system.

7. The method of claim 5 wherein the adjunct data consists of annotations input into remote computing devices by the individuals to generate the audio stream.

8. The method of claim 7 wherein the annotations are selected from the group consisting of: predetermined menu items denoting different assessments of content of the audio stream and free-form text notations.

9. The method of claim 8 wherein the predetermined menu items are selected from the group consisting of: a menu item indicating an important conversational point in the audio stream and a menu item indicating a conversational point in the audio stream requiring a subsequent action.

10. The method of claim 7 wherein the annotations indicate a degree of consensus of the individuals participating in the telephone call.

11. The method of claim 10 wherein the degree of consensus is represented as a numerical vote outcome of the individuals polled during the call.

12. The method of claim 5 wherein the adjunct data includes identification of electronic documents displayed to the individuals over the Internet.

13. The method of claim 12 wherein the adjunct data includes a making of annotations to the electronic documents by the individuals during the call, the annotations identifying an electronic document being annotated and the annotations.

14. The method of claim 5 wherein the adjunct data is generated by a program running on an electronic computer analyzing the audio stream to provide adjunct data related to a content of the audio stream.

15. The method of claim 14 wherein the adjunct data is selected from the group consisting of: a text transcription of the audio stream and identification of speaker characteristics of individuals recorded in the audio stream.

16. The method of claim 15 wherein the speaker characteristics are selected from the group consisting of: gender, emotional state, and loudness.

17. A method of improving an accessibility of recorded telephone conversations using at least one electronic computer executing a program stored in non-transient media to execute the steps of:
(a) interconnecting multiple conference users over a public telephone switch network to exchange audio data over the public telephone switch network;
(b) interconnecting the multiple conference users over the Internet to exchange non-audio data over the Internet contemporaneous with the exchange of audio data; and
(c) recording the audio data with the non-audio data to provide indexing of the audio data by the non-audio data.

18. A method of accessing audio stream data indexed by time and non-audio stream data linked to portions of the audio stream data wherein the non-audio stream data represents episodic annotations of the audio stream data comprising the steps of:
(a) displaying visual representations of the episodic non-audio stream data;
(b) accepting input from a user designating a displayed visual representation of the episodic non-audio stream data to return a portion of the audio stream data linked to the non-audio stream data associated with the visual representation.

19. The method of claim 18 wherein the visual representation of the episodic non-audio stream data is in tabular form.

20. The method of claim 18 wherein the visual representation of the episodic non-audio stream data is in outline form.

21. The method of claim 18 further providing a one-dimensional visual representation of the audio stream data as a function of time;
wherein the visual representation of the non-audio episodic stream data are tags positioned along the one-dimensional representation to align with times of the audio stream data to which it is linked; and
wherein the user inputs designate one of a time value or a display tag to play a portion of the audio stream data related to the time value or display tag.

22. A data structure for recording telephone conversations as electronic data fixed in non-transient media, the data structure comprising:
a header indicating that the electronic data is annotated audio data;
an audio stream providing audio samples at a predetermined sample interval;
adjunct data related to a content of the audio stream and linked to portions of the audio stream; and
electronic documents related to the audio stream having portions linked to the audio stream.
